(19) United States
(12) Patent Application Publication
(10) Pub. No.: US 2013/0009866 A1
(43) Pub. Date: Jan. 10, 2013

(54) INPUT PROCESSING APPARATUS

(76) Inventors: Shinji Hirano, Miyagi-ken (JP); Tsuyoshi Narusawa, Miyagi-ken (JP)

(21) Appl. No.: 13/543,509

(22) Filed: Jul. 6, 2012

(30) Foreign Application Priority Data
Jul. 7, 2011 (JP) 2011-150604

(51) Int. Cl. G06F 3/01

(52) U.S. Cl. 345/156

(57) ABSTRACT

In a keyboard input device, a first input device and a second input device each including a stick pointer are arranged. An input control of gesture functions such as zoom-in, zoom-out, right rotation, left rotation, forward tracking, backward tracking, left tracking, right tracking, and the like may be made possible by a combination of operational directions of operation bodies of the stick pointer (SP1) of the first input device and the stick pointer (SP2) of the second input device.

### CLAIM OF PRIORITY

This application claims benefit of Japanese Patent Application No. 2011-150604 filed on Jul. 7, 2011, which is hereby incorporated by reference in its entirety.

### BACKGROUND

1. Field of the Disclosure

The present disclosure relates to an input processing apparatus in which an input unit including a stick pointer is arranged at two portions of an operation input unit including a keyboard input device, and the like, in an information processing apparatus.

2. Description of the Related Art

On an operation panel of a personal computer, a keyboard input device and an input unit having a stick pointer are provided. Since an operation body of the input unit is arranged between keys constituting the keyboard input device, fingers can operate the stick pointer while hands are maintained in a posture of operating the keyboard input device, so that an input operation can be speedily performed.

Japanese Unexamined Patent Application Publication No. 2007-328475 discloses an input processing apparatus in which two input units having a stick pointer are arranged within a region of an array of keys in a keyboard input.

In the input processing apparatus, two independent cursors displayed on a screen can be individually controlled by two stick pointers, and a cursor can be controlled by one stick pointer while a scroll operation is performed by the other stick pointer, or the like.

As in the related art, in the input processing apparatus in which a single stick pointer is provided in the keyboard input device, control may only be performed so as to move a cursor displayed on the screen by generating an input signal of single coordinate data by an operation of the stick pointer, so that a variety of input controls may not be performed.

In the input processing apparatus disclosed in Japanese Unexamined Patent Application Publication No. 2007-328475, the input unit having the stick pointer is provided at two portions, so that it is possible to generate: the input signal of two kinds of coordinate data. However, what is being performed is limited to a movement control of the cursor and a scroll control, so that a variety of other input controls may not be performed.

### SUMMARY

An input processing apparatus, includes: a first input unit and a second input unit that are arranged in an operation input unit; a control processing unit to which an input signal from the first input unit and an input signal from the second input unit are applied; and a stick pointer that is provided in each of the first input, unit and the second input unit, and includes an operation body and a detection element for detecting an operational direction and an operational force which are applied to the operation body, wherein, when the input signal is obtained from the stick pointer of any one of the first input unit and the second input unit, a coordinate input process corresponding to the operational direction and the operational force which are applied to the operation body of the stick pointer is performed in the control processing unit, and when the input signal is obtained from the two stick pointers of the first input unit and the second input unit, a gesture control process in accordance with a combination of the operational directions applied to two operation bodies is performed in the control processing unit.

### BRIEF DESCRIPTION OF THE DRAWINGS

FIG. 1 is a perspective diagram showing a personal computer including an input processing apparatus according to an embodiment of the invention;

FIG. 2 is a plane diagram showing an input processing apparatus according to an embodiment of the invention;

FIG. 3 is a perspective diagram explaining a structure of each of the input units;

FIG. 4 is a circuit diagram of a detection element constituting a stick pointer;

FIG. 5 is a circuit block diagram of an input processing apparatus;

FIG. 6 is a circuit block diagram of another configuration example;

FIG. 7 is a flowchart showing a processing operation of an input processing apparatus;

FIG. 8 is an explanatory diagram showing a list of a gesture control processes, which are performed in a control processing unit;

FIG. 9 is a perspective view showing a portable information processing apparatus including an input processing apparatus according to an embodiment of the invention;

FIG. 10 is a perspective view showing a portable device including an input processing apparatus according to an embodiment of the invention; and

FIG. 11 is a perspective view showing a small-sized information processing apparatus including an input processing apparatus according to an embodiment of the invention.

### DESCRIPTION OF THE EXEMPLARY EMBODIMENTS

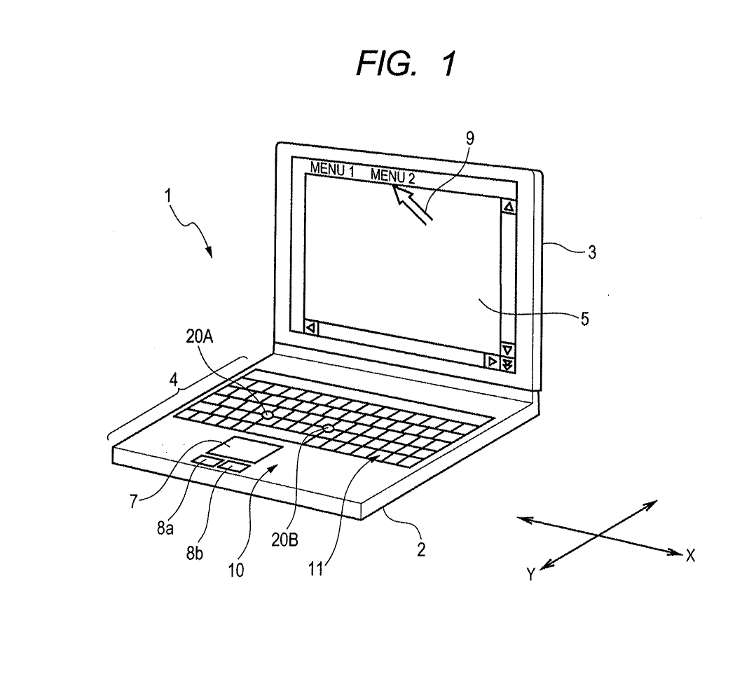

In FIG. 1, as an example of an information processing apparatus, a personal computer 1 is shown. A main body portion 2 and a lid body portion 3 are foldably connected to the personal computer 1. An operation input unit 4 is provided on a surface of the main body portion 2, and a display screen of a display device 5 that is formed of a liquid crystal display panel is provided on a surface facing a frontward side of the lid body portion 3.

In the operation input unit 4, an input processing apparatus 10 and a keyboard input device 11 according to an embodiment of the invention, a touch pad 7 which is arranged at a side further to the front than the keyboard input device 11, and a left click button 8a and a right click button 8b which are arranged in adjacent positions at a front side of the touch pad 7 are provided. The touch pad 7 outputs coordinate data corresponding to a contact position of a finger by a change in capacitance generated when the finger is in contact with the touch pad 7.

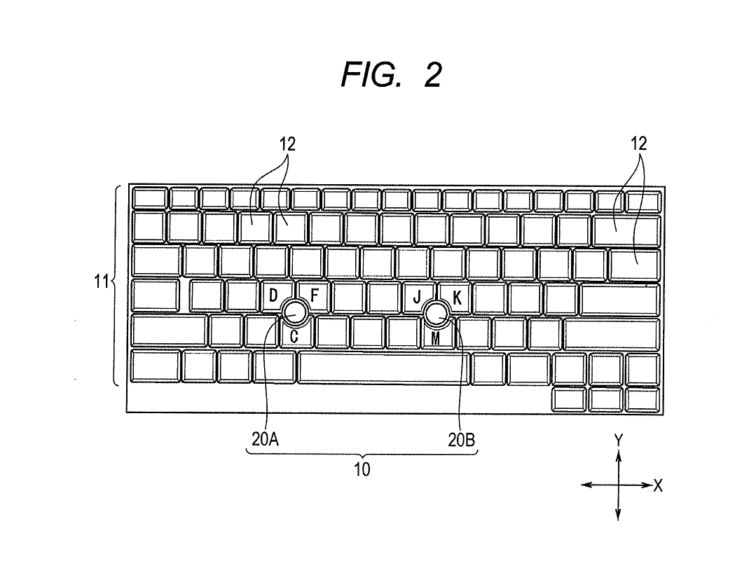

As shown in FIGS. 1 and 2, a plurality of keys 12, which are regularly, arranged toward an X direction and a Y direction are provided in the keyboard input device 11. The input processing apparatus 10 includes a first input unit 20A and a second input unit 20B, which are positioned within an arrangement region of the plurality of keys 12. On a substrate positioned below each of the plurality of keys 12, a key switch, which is pressed and operated by each of the keys 12, is provided.

The first input unit 20A and the second input unit 20B are arranged between the keys 12 adjacent to each other. In an example shown in FIG. 2, the first input unit 20A is arranged between the keys 12 for inputting “D”, “F”, and “C”, and easily operated mainly by the finger of a left hand. The second input unit 20B is arranged between the keys 12 for inputting “J”, “K”, and “M”, and easily operated mainly by the finger of a right hand.

An arrangement position of the first input unit 20A and the second input unit 20B is not limited to the embodiment shown in FIG. 2; however, it is preferable that the first input unit 20A and the second input unit 20B be arranged while keeping gaps therebetween in the X direction in the keyboard input device 11, so that the first input unit 20A and the second input unit 20B are individually arranged at a position to be easily operated using the finger of the left hand and the finger of the right hand in a posture of operating the keys 12 of the keyboard input device 11.

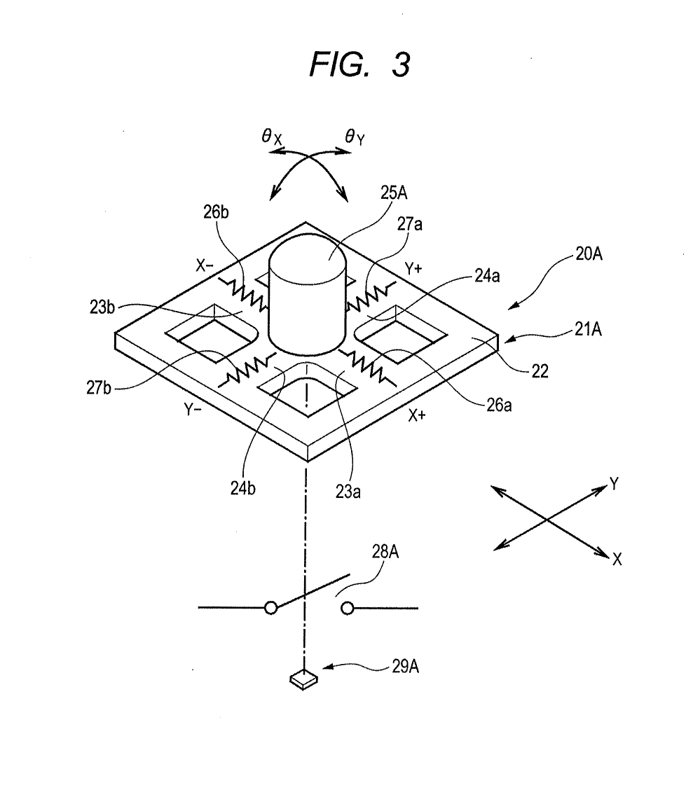

In FIG. 3, a structure of the first input unit 20A is illustrated. The first input unit 20A includes a first stick pointer 21A and a first switch unit 28A, and a first light source 29A.

The first stick pointer 21A includes a supporting base 22 formed of a synthetic resin, and a plus X-deformable portion 23a and a minus X-deformable portion 23b which extend in an X direction, and a plus Y-deformable portion 24a and a minus Y-deformable portion 24b which extend in a Y direction are integrally formed on the supporting base 22. At a center of the supporting base 22, a first operation body 25A that protrudes upward is integrally provided. The first operation body 25A is positioned at a center between the plus X-deformable portion 23a and the minus X-deformable portion 23b, and the plus Y-deformable portion 24a and the minus Y-deformable portion 24b.

An outer edge portion of the supporting base 22 is fixed to a substrate of the keyboard input device 11. When an operational force is applied to the first operation body 25A from the finger in an X direction, a Y direction, or the like, curvature occurs in the plus X-deformable portion 23a, the minus X-deformable portion 23b, the plus Y-deformable portion 24a, and the minus Y-deformable portion 24b in such a manner as to correspond to the operational direction and the operational force.

In the supporting base 22, a plus X-strain sensor 26a is mounted on an upper surface of the plus X-deformable portion 23a, and a minus X-strain sensor 26b is mounted on an upper surface of the minus X-deformable portion 23b. A plus Y-strain sensor 27a is mounted on an upper surface of the plus Y-deformable portion 24a, and a minus Y-strain sensor 27b is mounted on an upper surface of the minus Y-deformable portion 24b. In addition, each of the strain sensors 26a, 26b, 27a, and 27b may be mounted on a lower surface of the deformable portions 23a, 23b, 24a, and 24b.

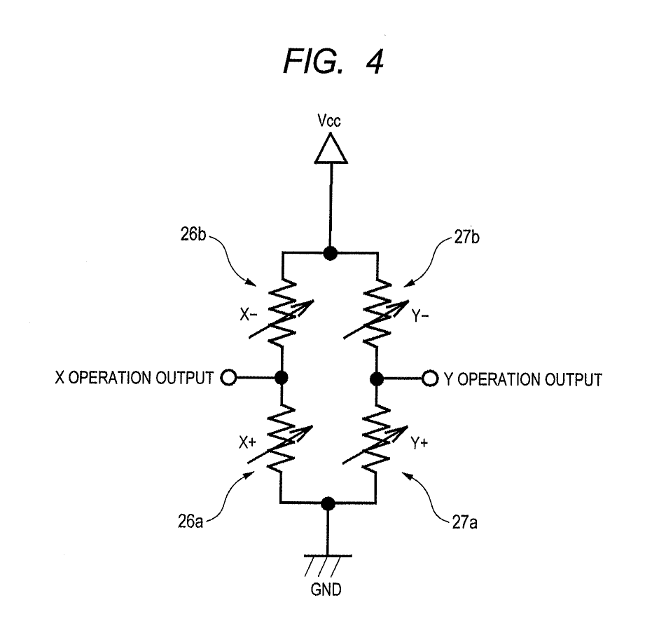

The strain sensors 26a, 26b, 27a, and 27b are detection elements of the first stick pointer 21A. Each of the strain sensors 26a, 26b, 27a, and 27b is a resistance film. The strain sensors 26a, 26b, 27a, and 27b are connected to each other, so that a bridge circuit shown in FIG. 4 is configured.

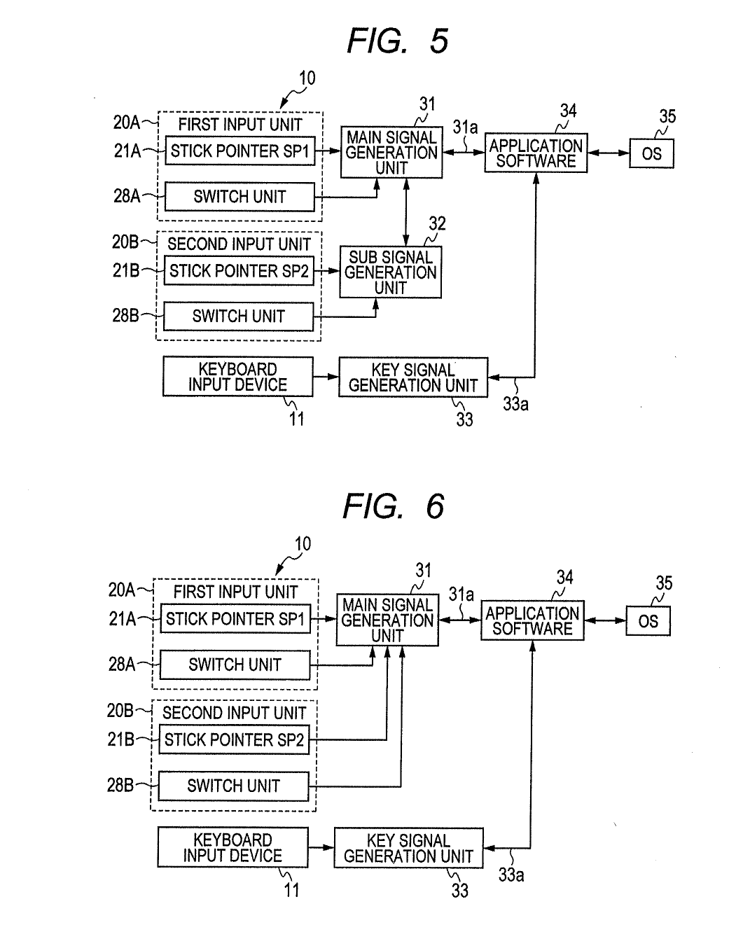

In FIG. 3, when the operation body 25A is pressed so as to fall in a θx direction, a θy direction, or the other direction, curvature occurs in the plus X-deformable portion 23a, the minus X-deformable portion 23b, the plus Y-deformable portion 24a, and the minus Y-deformable portion 24b in such a manner as to correspond to the pressed direction and a force to be pressed, so that a resistance value of each of the strain sensors 26a, 26b, 27a, and 27b is changed. In accordance with the change in the resistance value, an X operation output and a Y operation output may be obtained from the bridge circuit shown in FIG. 5.

As shown in FIG. 3, the first switch unit 28A provided in the first input unit 20A is provided below the supporting base 22 of the first stick pointer 21A, and, when the first operation body 25A is pushed toward a straight downward axial direction, the contact point conducts so that the first switch unit 28A enters an on state. In the embodiment shown in FIG. 3, the mechanical first switch unit 28A having the contact point constitutes a switch function of the first input unit 20A. However, when the first operation body 25A is pushed toward a straight downward axial direction without providing the mechanical switch unit, a switch circuit for detecting that the resistance values of the respective strain sensors 26a, 26b, 27a, and 27b are changed in the same direction at the same time may be separately provided to thereby constitute the switch function.

The first light source 29A provided in the first input unit 20A includes a single or a plurality of LEDs that emit light having different colors. At least a part of the first operation body 25A has a configuration that transmits the light, so that the first operation body 25A is brightly illuminated when the first light source 29A lights.

A structure of the second input unit 20B is the same as that of the first input unit 20A. The second input unit 20B includes a second stick pointer 21B having the same structure as that shown in FIG. 3, a second operation body 25B, a second switch unit 28B, and a second light source 29B.

FIG. 5 is a block diagram showing a circuit configuration of the input processing apparatus 10.

An X operation output and a Y operation output of the first stick pointer 21A of the first input unit 20A, and a switch detection output of the first switch unit 28A are applied to a main signal generation unit 31. An X operation output and a Y operation output of the second stick pointer 21B of the second input unit 20B, and a switch detection output of the second switch unit 28B are applied to a sub signal generation unit 32.

Each output of the second input unit 20B is A/D-converted in the sub signal generation unit 32, converted into a signal of predetermined bytes, and transmitted to the main signal generation unit 31. In the main signal generation unit 31, each output of the first input unit 20A is A/D-converted, and converted to an input signal of predetermined bytes, together with an output signal from the second input unit 20B which is applied from the sub signal generation unit 32 to thereby be formatted.

A key detection output applied from each of the key switches of the keyboard input device 11 is A/D-converted in a key signal generation unit 33, and converted into an input signal having a predetermined number of bytes to thereby be formatted.

The main signal generation unit 31, the sub signal generation unit 32, and the key signal generation unit 33 are constituted of an integrated circuit that is mounted on the substrate of the keyboard input device 11.

An input signal 31a generated in the main signal generation unit 31 and an input signal 33a generated in the key generation unit 33 are applied to an application software 34 installed in a main body control unit of the personal computer 1. Next, control information that is executed in the application software 34 is applied to an operation system (OS) 35, so that a display screen of the display device 5 of the personal computer 1 is controlled. In the present embodiment, a control operation of the application software 34 functions as a control processing unit.

As shown in a modified example shown in FIG. 6, only the main signal generation unit 31 may be provided without the sub signal generation unit 32. In this case, a detection output of the first stick pointer 21A and a switch detection output of the first switch unit 28A, and a detection output of the second stick pointer 21B and a switch detection output of the second switch unit 28B are all applied to the main signal generation unit 31. The detection output from the first input unit 20A and the detection output from the second input unit 20B are A/D-converted in the main signal generation unit 31, so that the formatted input signal 31a having the predetermined number of bytes is generated to be applied to the application software 34.

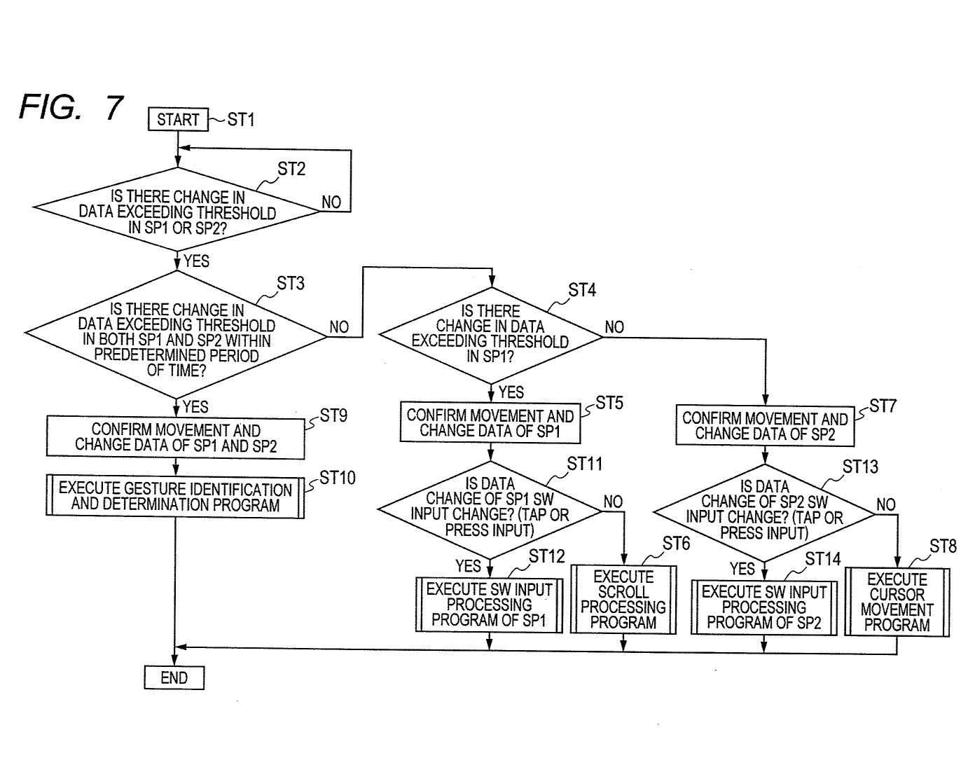

Next, an operation control of the input processing apparatus 10 will be described. In a flowchart shown in FIG. 7, each step is shown as “ST”.

When power is turned on and the application software 34 is enabled, a processing operation starts in ST1 (step 1). In ST2, the input signal 31a from the main signal generation unit 31 is monitored by a control operation of the application software 34, and whether a change exceeding a threshold value in at least one of an input signal from the first stick pointer (SP1) 21A of the first input unit 20A and an input signal from the second stick pointer (SP2) 21B of the second input unit 20B occurs is determined.

When exceeding the threshold value, in ST3, whether the input signals from both the first stick pointer 21A and the second stick pointer 21B exceed the threshold value is determined. Here, both the input signal from the first stick pointer 21A and the input signal from the second stick pointer 21B simultaneously exceed the threshold value, it is determined that “the input signals from both exceed the threshold value”. In addition, when both the input signal from the first stick pointer 21A and the input signal from the second stick pointer 21B exceed the threshold value within a fixed period of time determined in advance, it is determined that “the input signals from both exceed the threshold value”.

That is, a monitoring time having a fixed length determined in advance is set, and when both the input signal from the first stick pointer 21A and the input signal from the second stick pointer 21B exceed the threshold value for the monitoring time, it is determined that “the input signals from both exceed the threshold value”. By repeatedly executing the monitoring time, it is possible to determine whether the first stick pointer 21A and the second stick pointer 21B are simultaneously operated.

In ST3, when it is not determined that both the input signal from the first stick pointer 21A and the input signal from the second stick pointer 21B exceed the threshold value, that is, when the input signal from any one stick pointers exceeds the threshold value, the corresponding step proceeds to ST4.

In ST4, when it is determined that the input signal from the first stick pointer 21A exceeds the threshold value, the corresponding step proceeds to ST5, and the input signal from the first stick pointer 21A is confirmed. When it is confirmed that the input signal from the first stick pointer 21A is a coordinate signal showing a movement of a predetermined distance or more in an X direction or a Y direction, the corresponding step proceeds to ST6, and an information group that is displayed on the screen of the display device 5 is subjected to a coordinate input process for scrolling in the X direction or the Y direction. In this instance, based on an operational direction applied to the first operation body 25A, a scroll direction is determined, so that a speed of a scroll process is varied in proportion to the magnitude of the operational force.

In ST4, when it is determined that the input signal from the first stick pointer 21A does not exceed the threshold value, the input signal from the second stick pointer is determined as exceeding the threshold value, and the corresponding step proceeds to ST7, and the input signal from the second stick pointer 21B is confirmed. When it is determined that the coordinate signal of the predetermined distance or more in the X direction or the Y direction is input from the second stick pointer 21B, the corresponding step proceeds to ST8, and a coordinate input process for moving a cursor 9 shown in the display screen of the display device 5 is performed.

In ST8, in accordance with a direction of the operational force applied to the second operation body 25B of the second input unit 20B, a movement direction of the cursor 9 is determined, so that a movement distance of the cursor 9 is determined in proportion to the magnitude of the operational force applied to the second operation body 25B.

In ST3, when it is determined that both the input signal from the first stick pointer 21A and the input signal from the second stick pointer 21B exceed the threshold value, the corresponding step proceeds to ST9, an operational direction and an operational force thereof from the coordinate signal from the first stick pointer 21A are confirmed, the operational direction and the operational force from the input signal of the second stick pointer 21B are confirmed, and the corresponding step proceeds to ST10.

In ST10, in accordance with both the input signals of the first stick pointer 21A and the second stick pointer 21B, a gesture signal to be executed is selected.

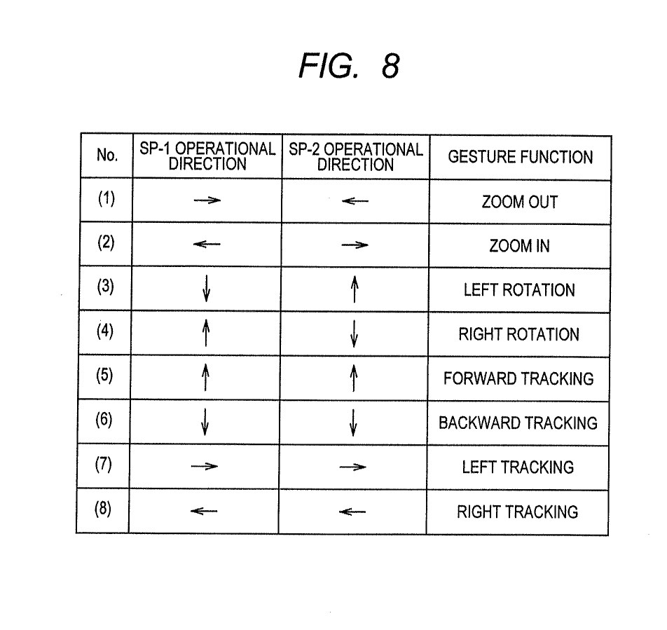

In FIG. 8, a correspondence table between the input signals of both the stick pointers 21A and 21B and the gesture signal is shown. As shown in FIG. 8, in the control process by the application software 34, the gesture signal is selected and generated based on a direction of coordinate data of the input signals of both the stick pointers 21A and 21B which are confirmed in ST9, and the generated gesture signal is subjected to the gesture control process.

As shown in (1) of FIG. 8, when an operational force in a right direction is applied to the operation body 25A of the first input unit 20A, and a coordinate signal in the plus X direction is obtained from the first stick pointer 21A, and together with that, when an operational force in a left direction is applied to the operation body 25B of the second input unit 20B, and a coordinate signal in the minus X direction is obtained from the second stick pointer 21B, a gesture control process of zoom-out is executed.

In the gesture control process of zoom-out, an image that is displayed on the screen of the display device 5 is reduced. In accordance with the magnitude of the operational force that is applied to the first operation body 25A and the second operation body 25B, a reduction ratio of the image is changed. In addition, since the first operation body 25A and the second operation body 25B are always going to return to a neutral position, a size of the image is returned to the initial size when the finger is separated from the first operation body 25A and the second operation body 25B. Alternatively, when the finger is separated from the first operation body 25A and the second operation body 25B, the reduced image may be maintained as is.

As shown in (2) of FIG. 8, when an operational force in a left direction is applied to the operation body 25A of the first input unit 20A, and a coordinate signal in the minus X direction is obtained from the first stick pointer 21A, and together with that, when an operational force in a right direction is applied to the operation body 25B of the second input unit 20B, and a coordinate signal in the plus X direction is obtained from the second stick pointer 21B, a gesture control process of zoom-in is executed.

In the gesture control process of zoom-in, the image that is displayed on the screen of the display device 5 is enlarged. In accordance with the magnitude of the operational force that is applied to the first operation body 25A and the second operation body 25B, an enlargement ratio of the image is changed. In addition, when the finger is separated from the first operation body 25A and the second operation body 25B, a size of the image is returned to the initial size. Alternatively, the enlarged image may be held as is.

As shown in (3) of FIG. 8, when an operational force facing a frontward side is applied to the operation body 25A of the first input unit 20A, and a coordinate signal in the minus Y direction is obtained from the first stick pointer 21A, and when the operational force facing the front side is applied to the operation body 25B of the second input unit 20B, and a coordinate signal in the plus Y direction is obtained from the second stick pointer 21B, a gesture control process of left rotation is performed.

In the gesture control process of left rotation, the image that is displayed on the screen of the display device 5 is rotated in a counter-clockwise direction with respect to an axis perpendicular to the screen. In accordance with the magnitude of the operational force that is applied to the first operation body 25A and the second operation body 25B, a rotational angle or a rotational speed of the image is changed. When the finger is separated from the first operation body 25A and the second operation body 25B, a rotational posture of the image is returned to the initial rotational posture.

As shown in (4) of FIG. 8, when an operational force in a frontward direction is applied to the operation body 25A of the first input unit 20A, and a coordinate signal in the plus Y direction is obtained from the first stick pointer 21A, and when the forward operational force is applied to the operation body 25B of the second input unit 20B, and a coordinate signal in the minus Y direction is obtained from the second stick pointer 21B, a gesture control process of right rotation is performed.

In the gesture control process of left rotation, the image that is displayed on the screen of the display device 5 is rotated in a clockwise direction with respect to the axis perpendicular to the screen. In accordance with the magnitude of the operational force that is applied to the first operation body 25A and the second operation body 25B, a rotational angle or a rotational speed of the image is changed. When the finger is separated from the first operation body 25A and the second operation body 25B, a rotational posture of the image is returned to a rotational posture of an initial stage.

As shown in (5) of FIG. 8, when an operational force in a frontward direction is applied to both the operation body 25A of the first input unit 20A and the operation body 25B of the second input unit 20B, and a coordinate signal in the plus Y direction is obtained from both the first stick pointer 21A and the second stick pointer 21B, a gesture control process of forward tracking is performed.

In the gesture control process of forward tracking, all of the images that are displayed on the screen of the display device 5 is moved downward (minus Y direction) at a high speed. The gesture control process of forward tracking is a processing operation different from the scroll control of ST6 of FIG. 7. In the scroll control, for example, a character string of the image displayed on the screen sequentially progresses in a Y direction; however, in the gesture control process of forward tracking, the images displayed on the screen become units of one group, and are successively gathered and moved in the minus Y direction.

Alternatively, in the gesture control process shown in (5) of FIG. 8, the images displayed on the screen may become one group, be gathered in an upward direction (plus Y direction) that is a movement direction of both hands, and be successively moved. In addition, when images that contain pictures or characters on the screen are displayed in page units, a gesture control process of right rotation-over is performed in (5) of FIG. 8, so that a page may be curled in the upward direction in accordance with a movement of both hands, and the next page may be shown.

As shown in (6) of FIG. 8, when an operational force in a frontward direction is applied to both the operation body 25A of the first input unit 20A and the operation body 25B of the second input unit 20B, and a coordinate signal in the minus Y direction is obtained from both the first stick pointer 21A and the second stick pointer 21B, a gesture control process of backward tracking is performed.

In the gesture control process of backward tracking, all of the images that are displayed on the screen of the display device 5 is moved at a high speed in an upward direction (plus Y direction). That is, the images displayed on the screen become units of one group, and are successively gathered and moved in the plus Y direction.

Alternatively, in the gesture control process shown in (6) of FIG. 8, the images displayed on the screen may become one group, be gathered in a downward direction (minus Y direction) that is a movement direction of both hands, and be successively moved. In addition, when images that contain pictures or characters on the screen are displayed in page units, a gesture control process of down turning-over is performed in (6) of FIG. 8, so that a page may be curled in the downward direction in accordance with a movement of both hands, and the next page may be shown.

As shown in (7) of FIG. 8, when an operational force in a right direction is applied to both the operation body 25A of the first input unit 20A and the operation body 25B of the second input unit 20B, and a coordinate signal in the plus X direction is obtained from both the first stick pointer 21A and the second stick pointer 21B, a gesture control process of left tracking is performed.

In the gesture control process of left tracking, all of the images that are displayed on the screen of the display device 5 becomes information of one group, is gathered, and is successively moved in a left direction (minus X direction).

Alternatively, all of the images may become one group, and may be successively moved in a right direction (plus X direction) in accordance with an operational direction of both hands. In addition, when the images that contain pictures or characters are displayed in page units, the gesture control process of right rotation-over by the gesture control process shown in (7) of FIG. 8 is performed, so that a page may be curled toward the right direction, and the next page may be shown.

As shown in (8) of FIG. 8, when an operational force in a left direction is applied to both the operation body 25A of the first input unit 20A and the operation body 25B of the second input unit 20B, and a coordinate signal in the minus X direction is obtained from both the first stick pointer 21A and the second stick pointer 21B, a gesture control process of right tracking is performed.

In the gesture control process of right tracking, all of the images that are displayed on the screen of the display device 5 becomes information of one group, is gathered, and is successively moved in a left direction (plus X direction).

Alternatively, all of the images may become one group, and may be successively moved in the left direction (minus X direction) in accordance with an operational direction of both hands. In addition, when the images that contain pictures or characters are displayed in page units, the gesture control process of left rotation-over by the gesture control process shown in (8) of FIG. 8 is performed, so that a page may be curled toward the left direction, and the next page may be shown.

When the gesture control processes shown in (5), (6), (7), and (8) of FIG. 8 are performed, the image may be moved by only one group, for example, only one page by a single operation with respect to the first operation body 25A and the second operation body 25B, and the number of turned-over pages may be increased, such as a turning-over operation of one page, a turning-over operation of two pages, a turning-over operation of three pages . . . , in proportion to the magnitude of the operational force applied to both the operation bodies 25A and 25B. Alternatively, while the operational force is repeatedly applied to the first operation body 25A and the second operation body 25B, pages of the image may be successively turned-over, and a speed at which a page is turned over may be changed in proportion to the magnitude of the operational force.

Next, when the operation body 25A of the first input unit 20A is pushed in an axial direction, the first switch unit 28A enters an on state, and when the operation body 25B of the second input unit 20B is pushed in the axial direction, the second switch unit 28B enters an on state. In this instance, a switch signal is transmitted to the application software 34 as the input signal 31a from the main signal generation unit 31.

In the control operation of the application software 34, different control processes are performed in accordance with which one of the first switch unit 28A and the second switch unit 28B is operated. For example, when the switch unit 28A of the first input unit 20A is operated, the same control process in which the left click button 8a shown in FIG. 1 is pressed is performed, and when the switch unit 28B of the second input unit 20B is operated, the same control process in which the right click button 8b shown in FIG. 1 is pressed is performed.

In addition, when both the first switch unit 28A and the second switch unit 28B are pressed, the same control process in which a middle click button positioned between the left click button 8a and the right click button 8b which are provided in a mouse is pressed is performed.

As described above, when the resistance values of four strain sensors 26a, 26b, 27a, and 27b which are provided in the stick pointers 21A and 21B are changed to the same state while the mechanical switch units 28A and 28B are not provided, it may be determined that the operation bodies 25A and 25B are pressed in the axial direction, and a first or a second switch function is operated.

In this case, in ST 11 of FIG. 7, when an output of the first stick pointer 21A is determined to be an output of the switch function, the corresponding step proceeds to ST12, and, for example, the same control process as that of the left click button 8a is performed. In ST13, when an output of the second stick pointer 21B is determined to be an output of the switch function, the corresponding step proceeds to ST14, and for example, the same control process as that of the left click button 8b is performed.

In addition, a setting menu is displayed on the screen of the display device 5 by starting the application software 34, and the keyboard input device 11 is operated, so that it is possible to change setting or allocation of a variety of gesture functions shown in FIG. 8, and setting or allocation of the switch functions of the first input unit 20A and the second input unit 20B.

In addition, as shown in FIG. 3, by controlling lighting of the first light source 29A for illuminating the first input unit 20A and the second light source 29B for illuminating the second input unit 20B, it is possible to illuminate the first operation body 25A and the second operation body 25B. In addition, by constituting each of the first light source 29A and the second light source 29B using a plurality of types of LEDs, it is possible to illuminate the first operation body 25A and the second operation body 25B with different colors.

For example, by executing each of the gesture control processes shown in (1) to (8) of FIG. 8, it is possible to illuminate the first operation body 25A and the second operation body 25B with different colors for each of the gestures.

In the present embodiment, in the application software 34 that functions as the control processing unit, as shown in FIG. 8, the direction of the input signal from the first stick pointer 21A and the second stick pointer 21B is determined, so that each of the gesture control processes is executed. However, in the invention, the input signals from the first stick pointer 21A and the second stick pointer 21B may be analyzed by a control circuit or a driver software which is provided at the preceding stage of the application software 34, and each of the gesture control operations may be instructed or executed.

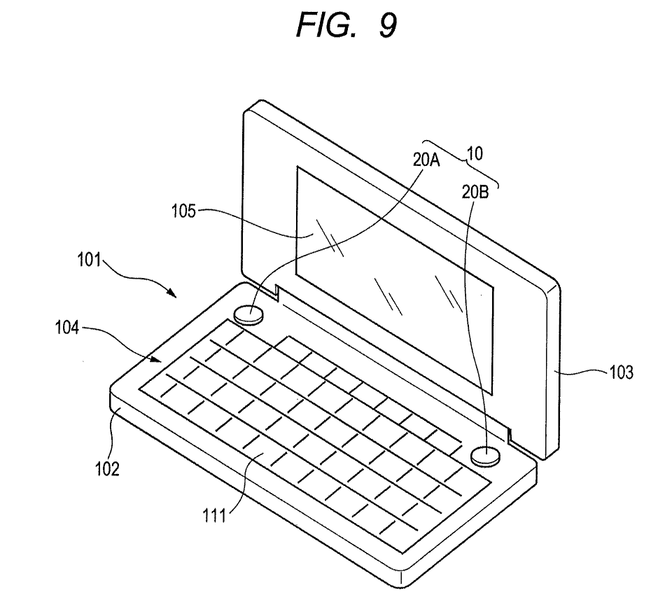

In FIGS. 9 to 11, another information processing apparatus in which the input processing apparatus 10 according to an embodiment of the invention is mounted is shown.

A portable information processing apparatus 101 is shown in FIG. 9. In the information processing apparatus 101, a small-sized main body portion 102 and a small-sized lid body portion 103 are freely foldably connected to each other. An operation input unit 104 is provided in the main body portion 102, and a display apparatus 105 is provided in the lid body portion 103. In the operation input unit 104, a small-sized keyboard input device 111, and a first input unit 20A and a second input unit 20B which constitute an input processing device 10 are provided. The first input unit 20A and the second input unit 20B are arranged at positions deviated to both left and right sides from a key arrangement region of the keyboard input device 111.

The information processing apparatus 101 is small-sized and is suitable for operating the main body portion 102 while holding the main body portion 102 with both hands, and for example, the first input unit 20A is operated by the thumb of the left hand, and the second input unit 20B is operated by the thumb of the right hand.

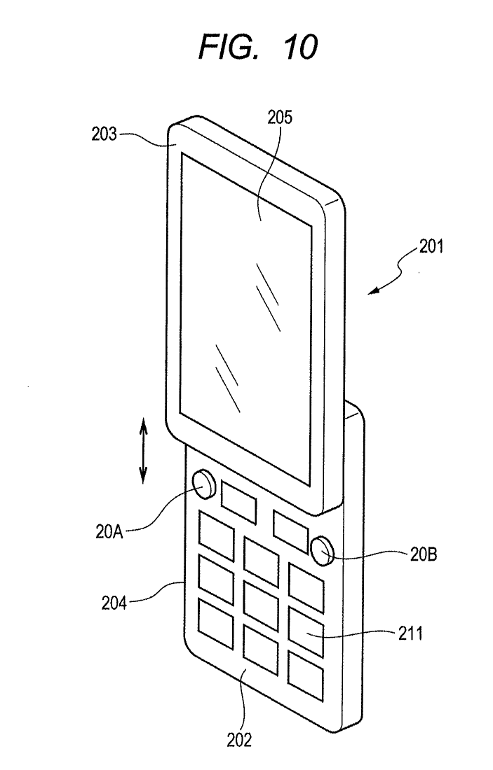

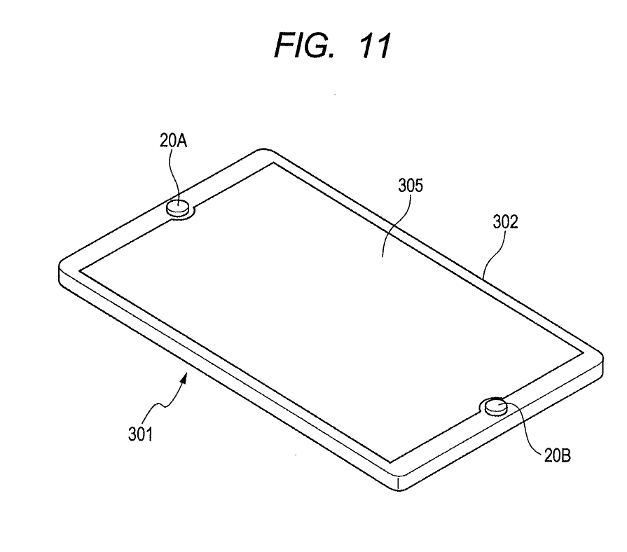

In FIG. 10, a portable device 201 having a telephone function and a mail-transmission and reception function is shown. The portable device 201 includes a main body portion 202 and a lid body portion 203 vertically slides on a front surface of the main body portion 202, and a display device 205 is provided in the lid body portion 203. An operation input unit 204 is provided in the main body portion 202, and the first input unit 20A and the second input unit 20B which constitute the input processing apparatus 10 are provided in the operation input unit 204, together with a ten key input unit 211.

A small-sized information processing apparatus 301 shown in FIG. 11 includes a main body portion 302 having a size to be held with both hands. A display device 305 is provided in the main body portion 302. The display device 305 includes a display unit such as a liquid crystal display panel, and the like, and a capacitance type touch pad or a variable-resistance type touch pad which is provided on a surface of the display unit. The first input unit 20A and the second input unit 20B, which constitute the input processing apparatus 10, are arranged in both sides of the display device 305.

In the information processing apparatus 301, a variety of input operations are made possible by touching the display screen using the finger, so that it is possible to operate the first input unit 20A with the thumb of the left hand, and the second input unit 20B with the thumb of the right hand.

It should be understood by those skilled in the art that various modifications, combinations, sub-combinations and alterations may occur depending on design requirements and other factors insofar as they are within the scope of the appended claims of the equivalents thereof.

What is claimed is:

1. An input processing apparatus, comprising:
a first input unit and a second input unit that are arranged in an operation input unit;
a control processing unit to which an input signal from the first input unit and an input signal from the second input unit are applied; and
a stick pointer provided in each of the first input unit and the second input unit, and including an operation body and a detection element that detects an operational direction and an operational force which are applied to the operation body,
wherein, when the input signal is obtained from the stick pointer of any one of the first input unit and the second input unit, a coordinate input process corresponding to the operational direction and the operational force which are applied to the operation body of the stick pointer is performed in the control processing unit, and when the input signal is obtained from two stick pointers of the first input unit and the second input unit, a gesture control process in accordance with a combination of the operational directions applied to two operation bodies is performed in the control processing unit.

2. The input processing apparatus according to claim 1, wherein, when the input signal is obtained from the stick pointer of any one of the first input unit and the second input unit, mutually different control processes are performed on the input signal from the first input unit and the input signal from the second input unit in the control processing unit.

3. The input processing apparatus according to claim 1, wherein a switch function for detecting that the operation body is pressed is provided in each of the first input unit and the second input unit, and different switch control processes are performed in the control processing unit when the switch function of the first input unit is operated and when the switch function of the second input unit is operated.

4. The input processing apparatus according to claim 3, wherein a setting and a change for correspondence between operations of two switch functions and the switch control process are made possible by changing a setting of the control processing unit.

5. The input processing apparatus according to claim 2, wherein a switch function for detecting that the operation body is pressed is provided in each of the first input unit and the second input unit, and different switch control processes are performed in the control processing unit when the switch function of the first input unit is operated and when the switch function of the second input unit is operated.

6. The input processing apparatus according to claim 5, wherein a setting and a change for correspondence between operations of two switch functions and the switch control process are made possible by changing a setting of the control processing unit.

7. The input processing apparatus according to claim 1, wherein the gesture control process is performed in the control processing unit when detection outputs are simultaneously obtained from the detection elements provided in two stick pointers.

8. The input processing apparatus according to claim 7, wherein, when the input signal is obtained from the stick pointer of any one of the first input unit and the second input unit, mutually different control processes are performed on the input signal from the first input unit and the input signal from the second input unit in the control processing unit.

9. The input processing apparatus according to claim 7, wherein a switch function for detecting that the operation body is pressed is provided in each of the first input unit and the second input unit, and different switch control processes are performed in the control processing unit when the switch function of the first input unit is operated and when the switch function of the second input unit is operated.

10. The input processing apparatus according to claim 9, wherein a setting and a change for correspondence between operations of two switch functions and the switch control process is made possible by changing a setting of the control processing unit.

11. The input processing apparatus according to claim 8, wherein a switch function that detects that the operation body is pressed is provided in each of the first input unit and the second input unit, and different switch control processes are performed in the control processing unit when the switch function of the first input unit is operated and when the switch function of the second input unit is operated.

12. The input processing apparatus according to claim 11, wherein a setting and a change for correspondence between operations of two switch functions and the switch control process are made possible by changing a setting of the control processing unit.

13. The input processing apparatus according to claim 1, wherein the gesture control process is performed within a predetermined period of time in the control processing unit when a detection output is obtained from the detection elements provided in two stick pointers.

14. The input processing apparatus according to claim 13, wherein, when the input signal is obtained from the stick pointer of any one of the first input unit and the second input unit, mutually different control processes are performed on the input signal from the first input unit and the input signal from the second input unit in the control processing unit.

15. The input processing apparatus according to claim 13, wherein a switch function that detects that the operation body is pressed is provided in each of the first input unit and the second input unit, and different switch control processes are performed in the control processing unit when the switch function of the first input unit is operated and when the switch function of the second input unit is operated.

16. The input processing apparatus according to claim 15, wherein a setting and a change for correspondence between operations of two switch functions and the switch control process are made possible by changing a setting of the control processing unit.

17. The input processing apparatus according to claim 14, wherein a switch function that detects that the operation body is pressed is provided in each of the first input unit and the second input unit, and different switch control processes are performed in the control processing unit when the switch function of the first input unit is operated and when the switch function of the second input unit is operated.

18. The input processing apparatus according to claim 17, wherein a setting and a change for correspondence between operations of two switch functions and the switch control process are made possible by changing a setting of the control processing unit.

19. The input processing apparatus according to claim 1, wherein a setting and a change for correspondence between the input signal from two input units and the control process to be executed are made possible by changing a setting of the control processing unit.

20. The input processing apparatus according to claim 1, wherein a light source that illuminates the operation body of the first input unit and the operation body of the second input unit with different colors is provided.
